(19) United States
(12) Patent Application Publication
(10) Pub. No.: US 2015/0015923 A1
(43) Pub. Date: Jan. 15, 2015

(54) IMAGE FORMING APPARATUS AND IMAGE FORMING METHOD

(71) Applicant: Kouji HAYASHI, Kanagawa (JP)

(72) Inventor: Kouji HAYASHI, Kanagawa (JP)

(73) Assignee: RICOH COMPANY, LTD., Tokyo (JP)

(21) Appl. No.: 14/329,069

(22) Filed: Jul. 11, 2014

(30) Foreign Application Priority Data
Jul. 12, 2013 (JP) 2013-146487

(51) Int. Cl. H04N 1/00

(52) U.S. Cl. CPC H04N 1/00819
USPC 358/474

(57) ABSTRACT

An image forming apparatus includes a γ conversion unit configured to perform γ conversion on image data acquired by scanning an image; an image forming unit configured to form the image data on an image carrier and a transfer sheet; a first and second calibration units respectively configured to perform first and second calibrations of generating a calibration parameter to be set in the γ conversion unit, based on a scan value of a plurality of gradation patterns formed on the transfer sheet and the image carrier; and a changing unit configured to change the calibration parameter or a calibration amount with respect to the second calibration, based on a first calibration result of the first calibration, a second calibration result of the first calibration executed after a property of the image forming unit has changed, and a calibration result of the second calibration.

### BACKGROUND OF THE INVENTION

1. Field of the Invention

The present invention relates to an image forming apparatus and an image forming method.

2. Description of the Related Art

Conventionally, in color copiers, the following technologies are used in combination for adjusting the image density to an appropriate level and maintaining the appropriate image density. One technology is a first calibration (ACC) technology of scanning, with a scanner, a gradation pattern (ACC pattern) output onto a transfer sheet, and calibrating the γ conversion table. The other technology is a second calibration (IBACC) technology of scanning, with an optical sensor facing an image carrier (intermediate transfer belt), a gradation pattern (IBACC pattern) formed on the image carrier and calibrating the γ conversion table according to the scan value of the optical sensor (see, for example, Patent Document 1).

In the second calibration, a plurality of IBACC patterns having different densities (area ratios) are scanned, and applied to γ conversion tables for copy applications having different gradation processes (quantization threshold, DATE process, etc.), and to γ conversion tables for printer applications having different gradation processes (dither process). To the γ conversion tables for copy applications and γ conversion tables for printer applications, gradation processes are applied, which have different numbers of lines according to the character mode, the image quality mode such as a photograph mode, and the resolution (600 dpi/1200 dpi). Accordingly, the time and labor required for the calibration are reduced.

However, when the gradation pattern used in the first calibration (ACC) and the gradation pattern used in the second calibration (IBACC) are different, there arises a problem in that the calibration precision by the second calibration is lower than the calibration precision by the first calibration.
Patent Document 1: Japanese Patent No. 3441994

### SUMMARY OF THE INVENTION

The present invention provides an image forming apparatus and an image forming method, in which one or more of the above-described disadvantages are eliminated.

According to an aspect of the present invention, there is provided an image forming apparatus including a scanning unit configured to scan an original image and acquire image data; a γ conversion unit configured to perform γ conversion on the image data; an image forming unit configured to form the image data on an image carrier and a transfer sheet; a first calibration unit configured to perform first calibration of generating a calibration parameter to be set in the γ conversion unit, based on a scan value of a plurality of gradation patterns formed on the transfer sheet; a second calibration unit configured to perform second calibration of generating a calibration parameter to be set in the γ conversion unit, based on a scan value of a plurality of gradation patterns formed on the image carrier; and a changing unit configured to change the calibration parameter or a calibration amount with respect to the second calibration, based on a first calibration result of the first calibration, a second calibration result of the first calibration executed after a property of the image forming unit has changed, and a calibration result of the second calibration.

According to an aspect of the present invention, there is provided an image forming method including scanning an original image and acquiring image data; performing γ conversion on the image data; forming the image data on an image carrier and a transfer sheet; performing first calibration of generating a calibration parameter to be set for the γ conversion, based on a scan value of a plurality of gradation patterns formed on the transfer sheet; performing second calibration of generating a calibration parameter to be set for the γ conversion, based on a scan value of a plurality of gradation patterns formed on the image carrier; and changing the calibration parameter or a calibration amount with respect to the second calibration, based on a first calibration result of the first calibration, a second calibration result of the first calibration executed after a property of the forming of the image data has changed, and a calibration result of the second calibration.

### BRIEF DESCRIPTION OF THE DRAWINGS

Other objects, features and advantages of the present invention will become more apparent from the following detailed description when read in conjunction with the accompanying drawings, in which:

FIG. 1 illustrates a configuration of an entire copier;

FIG. 2 illustrates a control system built in the copier;

FIG. 3 illustrates a configuration of an image forming apparatus to which an embodiment of the Present invention is applied;

FIG. 4 is for describing a calibration process of a gradation conversion table according to an embodiment of the present invention;

FIG. 5 is a flowchart of procedures for acquiring a gradation calibration γ property of FIG. 4;

FIG. 6 is a process flowchart of ACC (Auto Color Calibration);

FIGS. 7A through 7C are for describing ACC;

FIG. 8 illustrates an IBACC detection pattern formed on an image carrier;

FIG. 9 is for describing a method of determining whether ACC execution is necessary;

FIG. 10 illustrates a screen of an operation unit reporting to execute ACC;

FIG. 11 is a flowchart of a process of updating the IBACC toner adherence amount property;

FIG. 12 is for describing the process of updating an IBACC reference value;

FIG. 13 is a flowchart of a process of acquiring a calibration value;

FIG. 14 is for describing the updating of a calibration value;

FIG. 15 is for describing a first calibration (initial) operation;

FIG. 16 is for describing an operation of generating a γ conversion table (LUT) for image processing;

FIG. 17 is for describing a second calibration operation; and

FIG. 18 is for describing a first calibration (second time) operation.

### DETAILED DESCRIPTION OF THE PREFERRED EMBODIMENTS

A description is given, with reference to the accompanying drawings, of embodiments of the present invention.

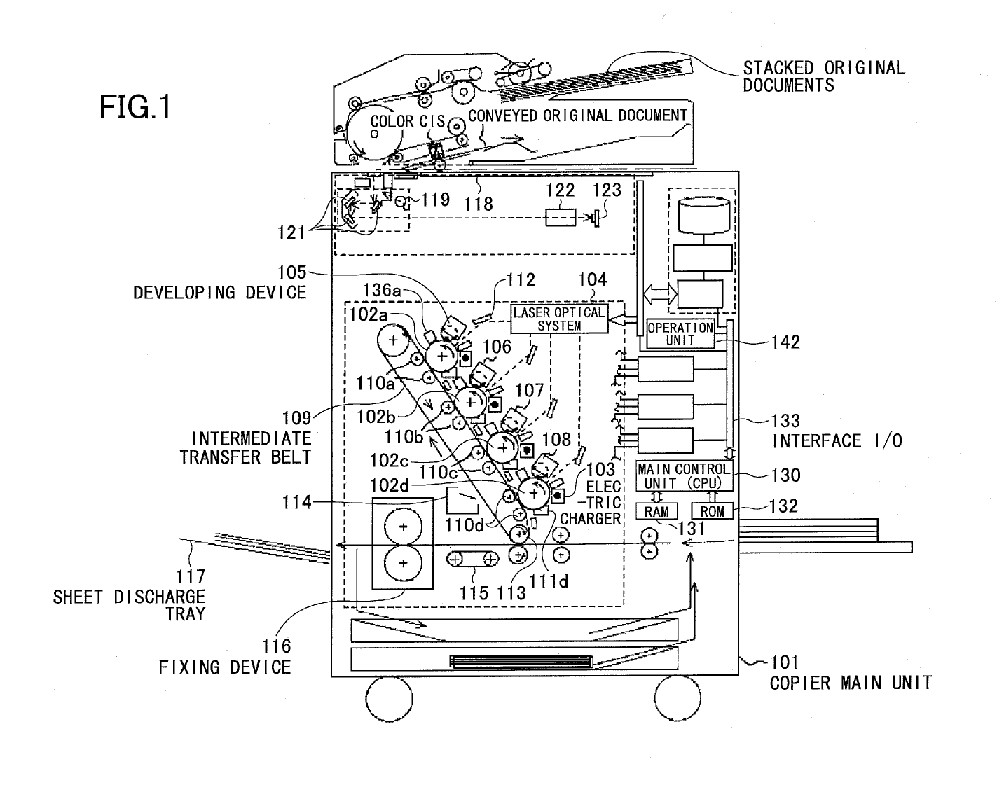

FIG. 1 illustrates a configuration of the entire copier. In FIG. 1, the following elements are sequentially arranged around each of the organic photoreceptor (OPC) drums 102a through 102d having a diameter of 33 mm, which are four image carriers arranged next to each other at the center part of a copier main unit 101. Specifically, the elements are electric chargers 103a through 103d for charging the surface of the photoreceptor drums 102a through 102d, laser optical systems 104a through 104d for radiating semiconductor laser beams on the surfaces of the photoreceptor drums 102a through 102d which have been uniformly charged to form electrostatic latent images, black developing devices 105a through 105d and three color developing devices 106a through 106d, 107a through 107d, and 108a through 108d of yellow Y, magenta M, and cyan C for supplying toner of respective colors to the electrostatic latent images to develop the images and obtaining toner images of the respective colors, an intermediate transfer belt 109 onto which the toner images of the respective colors, which are formed on the photoreceptor drums 102a through 102d, are respectively transferred, bias rollers 110a through 110d for applying a transfer voltage onto the intermediate transfer belt 109, cleaning devices 111a through 111d for removing the toner remaining on the surfaces of the photoreceptor drums 102a through 102d after the transfer process, and neutralization units 112a through 112d for removing the electric charges remaining on the surfaces of the photoreceptor drums 102a through 102d after the transfer process.

Furthermore, at the intermediate transfer belt 109, there are arranged a transfer bias roller 113 for applying a voltage for transferring the toner image, which has been transferred onto the intermediate transfer belt 109, onto a transfer material, and a belt cleaning device 114 for cleaning the toner image remaining on the intermediate transfer belt 109 after the process of transferring the toner image onto the transfer material.

At the outlet side end part of a conveying belt 115 conveying the transfer material that has been peeled off the intermediate transfer belt 109, there is arranged a fixing device 116 for fixing the toner image by applying heat and pressure, and a sheet discharge tray 117 is attached to the outlet part of the fixing device 116.

Above the laser optical system 104, there is a contact glass 118 that is an original document mounting stand arranged on top of the copier main unit 101. Furthermore, there is an exposing lamp 119 for radiating scanning light on the original document on the contact glass 118. The light reflected from the original document is guided to an imaging lens 122 by a reflection mirror 121, and is entered into an image sensor array 123 of a CCD that is a photoelectric conversion element. Image signals, which have been converted into electric signals at the image sensor array 123 of the CCD, control the laser oscillation of the semiconductor laser in the laser optical system 104, via an image processing device (not shown).

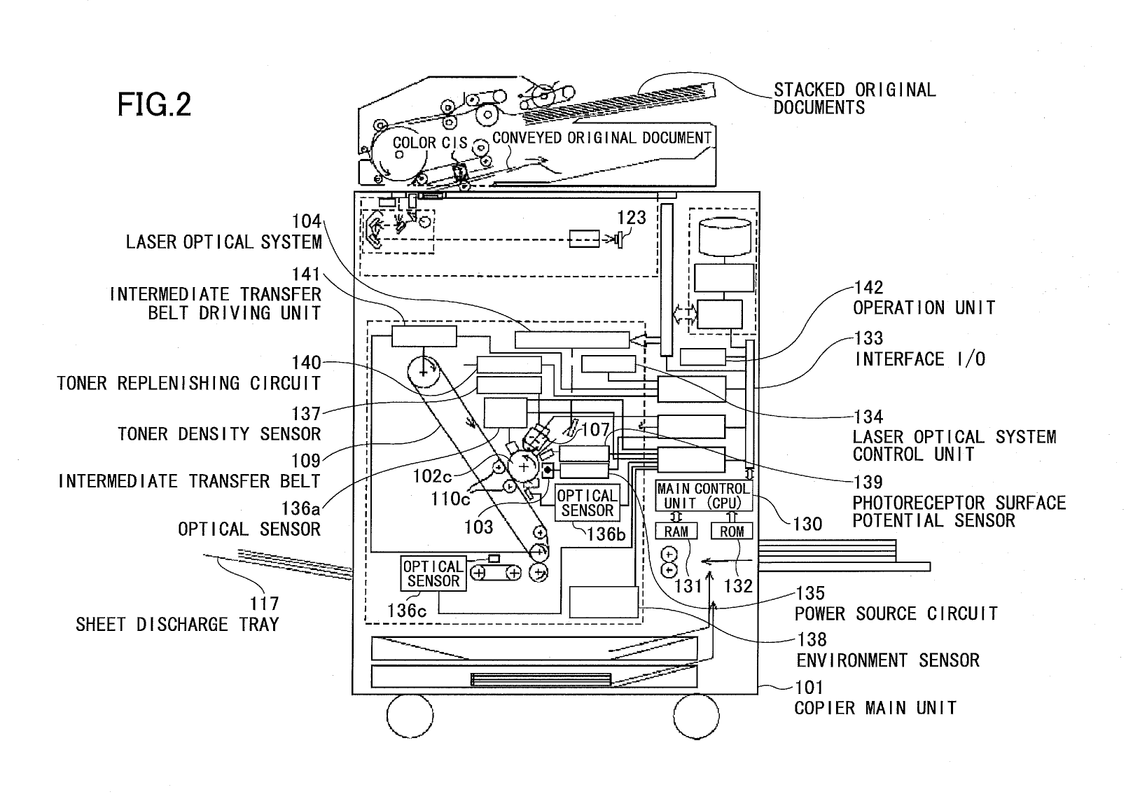

Next, a description is given of a control system built in the above copier. As illustrated in FIG. 2, the control system includes a main control unit (CPU) 130. With respect to the main control unit 130, a predetermined RAM 131 and ROM 132 are attached. Furthermore, to the main control unit 130, there are connected, via an interface I/O 133, a laser optical system control unit 134, a power source circuit 135, an optical sensor 136 provided in each of the YMCK image forming units, a toner density sensor 137 provided in each of the YMCK developing devices, an environment sensor 138, photoreceptor surface potential sensors 139a through 139d, a toner replenishing circuit 140, an intermediate transfer belt driving unit 141, and an operation unit 142.

The laser optical system control unit 134 is for adjusting the laser output of the laser optical systems 104a through 104d. The power source circuit 135 applies a predetermined discharging voltage used for charging to the electric chargers 103a through 103d, applies a developing bias of a predetermined voltage to the black developing devices 105a through 105d, and color developing devices 106a through 106d, 107a through 107d, 108a through 108d, and applies a predetermined transfer voltage to the bias rollers 110a through 110d and the transfer bias rollers 113a through 113d.

Note that as the optical sensor 136, optical sensors 136a respectively facing the photoreceptor drums 102a through 102d for detecting the amount of toner adhering on the photoreceptor drums 102a through 102d, an optical sensor 136b facing the intermediate transfer belt 109 for detecting the amount of toner adhering on the intermediate transfer belt 109, and an optical sensor 136c facing the conveying belt for detecting the amount of toner adhering on the conveying belt, are illustrated. Note that in practical use, the detection may be performed at any one of the locations of the optical sensors 136a through 136e.

The optical sensor 136 (a through c) is constituted by a light emitting element such as a light emitting diode and a light receiving element such as a photosensor, arranged near the area where the transfer process has been performed on the photoreceptor drums 102a through 102d. The optical sensor 136 (a through c) detects the amount of adhering toner in the toner image of the detection pattern latent image formed on the photoreceptor drum 102 and the amount of adhering toner in the background for each color, and detects the so-called residual potential after neutralizing the photoreceptor.

The detection output signals from the optical sensor 136 (a through c) are applied to an optical sensor control unit (not shown). The optical sensor control unit obtains the ratio between the toner adherence amount of the detection pattern toner image and the toner adherence amount of the background part, compares the ratio value with a reference value to detect the variation in the image density, and calibrates the control value of the toner density sensor 137 of the respective colors of YMCK.

Furthermore, the toner density sensor 137 detects the toner density based on the change in the magnetic permeability of the developer present in the black developing devices 105a through 105d and the color developing devices 106a through 106d, 107a through 107d, and 108a through 108d. The toner density sensor 137 has a function of comparing the detected toner density value with a reference value, and when the toner density is below a certain value and there is a deficiency in the toner, the toner density sensor 137 applies toner replenishing signals having a value corresponding to the deficient amount, to the toner replenishing circuit 140.

The photoreceptor surface potential sensors 139a through 139d respectively detect the surface Potential on the photoreceptor drums 102a through 102d that are image carriers, and the intermediate transfer belt driving unit 141 controls the driving of the intermediate transfer belt 109.

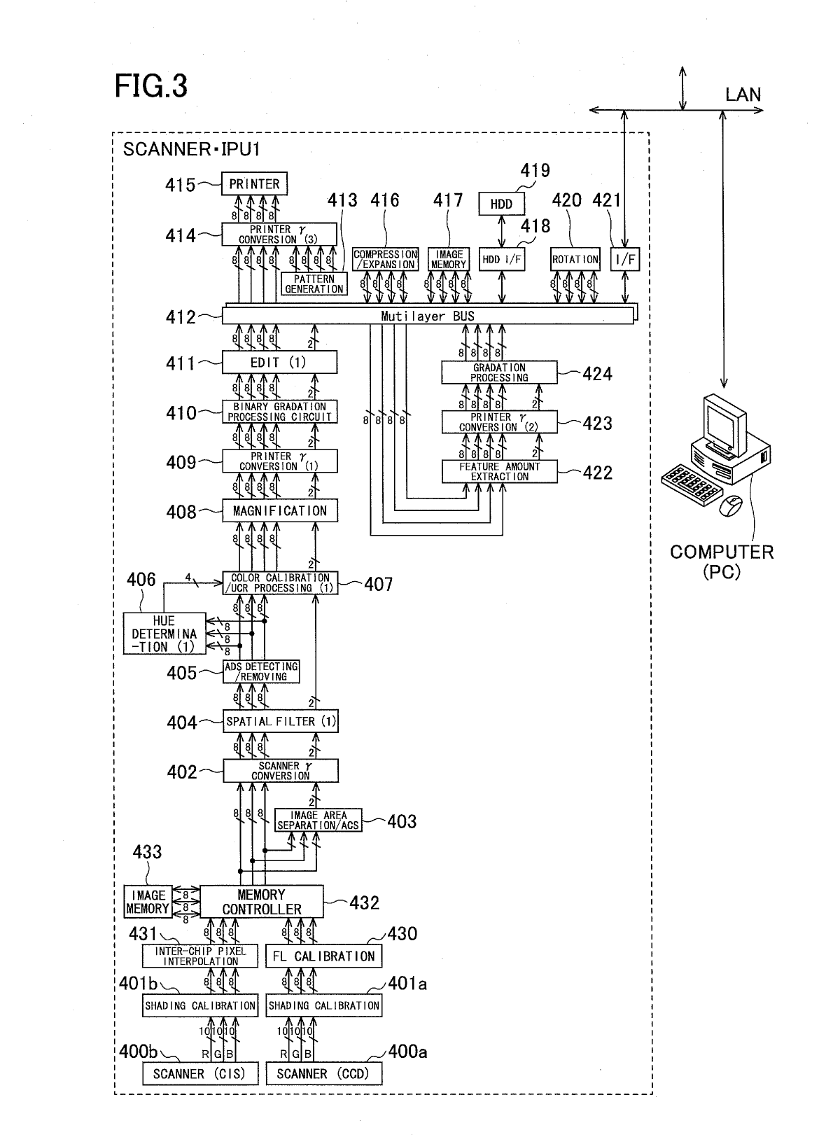

FIG. 3 illustrates a configuration of an image forming apparatus to which an embodiment of the present invention is applied. The image forming apparatus in FIG. 3 includes a scanner 400a that uses a CCD as a scanning device, a scanner 400b that uses a CIS (Contact Image Sensor) as a scanning device, a shading calibration circuit 401a for the scanner (CCD) 400a, a shading calibration circuit 401b for the scanner (CIS) 400b, an FL calibration processing circuit 430 for the scanner (CCD) 400a, an inter-chip pixel interpolation circuit 431 for the scanner (CIS) 400b, a memory controller 432, an image memory 433, a scanner γ conversion circuit 402, an image area separation/ACS determination circuit 403, a spatial filter 404, an automatic density adjustment level detecting/removing circuit 405, a hue determination circuit 406, a color calibration/UCR processing circuit 407, a magnification processing circuit 408, a printer γ conversion (1) circuit 409, a binary gradation processing circuit 410, an edit processing circuit 411, a mutilayer bus 412, a pattern generation circuit 413, a printer γ conversion (3) circuit 414, a printer 415, a feature amount extraction processing circuit 422, a printer γ conversion (2) circuit 423, a gradation processing circuit 424, a compression/expansion circuit 416, an image memory 417, a HDD I/F 418, a HDD 419, a rotation processing circuit 420, and an external interface I/F 421.

As for the original document to be copied, when double-sided simultaneous scanning has been specified by the user, one side of the original document is set as the front side and is color-separated into R, G, B and scanned by the color scanner (CCD) 400a as 10 bit signals, for example. Furthermore, the side opposite to the front side of the original document is set as the back side. By one conveying operation, both sides of the original document are simultaneously scanned by the color scanner (CIS) 400b.

In the image signals scanned by the scanner (CCD) 400a, the unevenness in the main-scanning direction is calibrated by the shading calibration circuit 401a, and the image signals are output as 8 bit signals. Similarly, in the image signals scanned by the scanner (CIS) 400b, the unevenness in the main-scanning direction is calibrated by the shading calibration circuit 401b, and the image signals are output as 8 bit signals. The FL calibration processing circuit 430 calibrates the difference in sensitivity (difference in gradation properties) of the two CCDs arranged in the main-scanning direction. The inter-chip pixel interpolation circuit 431 interpolates the image data at the end between chips in the CIS device arranged in the main-scanning direction, from adjacent pixels on either side.

The memory controller 432 is a DDR memory controller for temporarily storing image data 1 or image data 2 in the image memory 433 using a DDR memory. The image data 1 is data that has been scanned by the scanner (CCD) 400a and that has undergone processing at the shading calibration circuit 401a and the FL calibration processing circuit 430. The image data 2 is data that has been scanned by the scanner (CIS) 400b and that has undergone processing at the shading calibration circuit 401b and the inter-chip pixel interpolation circuit 431.

The image area separation/ACS determination circuit 403 outputs, for each pixel of the image data 1 and the image data 2, an image area separation determination result (signal X) such as a character area and a photograph area, and a color determination result of whether the original document is a color original document or a monochrome original document.

The scanner γ conversion circuit 402 converts the scan signals from the scanner, from reflectance data to brightness data. The image memory 433 stores the image signals that have undergone the scanner γ conversion, and the image area separation/ACS determination circuit 403 determines the character part and the photograph part, and determines whether the image is in chromatic colors or achromatic colors.

The spatial filter 404 performs processes for forming a sharp image or a soft image according to the user's preference. Specifically, the spatial filter 404 performs a process of chaining the frequency properties of the image signals, such as edge enhancement and smoothing, and also performs an edge enhancement process (adaptive edge enhancement process) according to the edge degree of the image signals. For example, so-called adaptive edge enhancement is performed on each of the R, G, and B signals, in which edge enhancement is performed for character edges, and edge enhancement is not performed for halftone images.

The color calibration process is performed at the color calibration/UCR processing circuit 407 described above. The color calibration/UCR processing circuit 407 includes a color calibration processing unit and a UCR processing unit. The color calibration processing unit calibrates the difference in the color separation properties of the input system and the spectroscopic properties of the color material of the output system and calculates the amount of YMC color materials required for true color reproduction. The UCR processing unit replaces the Part where the three colors of YMC are superposed, with Bk (black).

The UCR process is performed by calculations using the following formulas.

Y′=Y−α·min(Y,M,C)

M′=M−α·min(Y,M,C)

C′=C−α·min(Y,M,C)

Bk=α·min(Y,M,C)

In the above formulas, α is a coefficient for determining the amount of UCR, and when α=1, a 100% UCR process is performed. The α value may be a constant value. For example, by setting the α value to be close to one in high density parts, and by setting the α value to be close to zero in highlight parts (low image density parts), it is possible to smoothen the image in the highlight parts.

The color calibration coefficient used in the color calibration process is different for each of the 12 hues obtained by dividing each of the six hues of RGBYMC by two, and the 14 hues of black and white. The hue determination circuit 406 determines the hue of the scanned image data, and based on the determination result, the color calibration coefficient for each hue is selected.

The magnification processing circuit 408 performs magnification in the main-scanning and sub-scanning directions. The printer γ conversion (1) circuit 409 performs printer γ conversion for characters and photographs according to image area separation signals, or the binary gradation processing circuit 410 performs printer γ conversion before the binarization process. At the time of fax transmission or scanner distribution, the binary gradation processing circuit 410 performs a binarization process such as a simple binarization process, a binary dither process, a binary error diffusion process, and a binary variation threshold error diffusion process, in accordance with a character mode, a photograph mode, or a character/photograph mode instructed from a PC connected to the operation unit 142 and the external interface I/F 421 via a LAN.

The edit processing circuit 411 performs an editing process such as an edge mask process and logic inversion. When saving image data, the image data is sent through the mutilayer bus 412 and undergoes a compression process at the compression/expansion circuit 416, and the compressed image data is saved in the HDD 419 via the HDD I/F 418. The saved image data is saved as RGB signals, K (Gray) signals, CMYK signals, and RGBX signals (X signals indicate the image area separation result), according to the usage purpose. The RGB signals are for distribution, the K (Gray) signals are for distribution and fax transmission, the CMYK signals are for printing onto paper, and the RGBX signals are for generating CMYK data or for performing reprocessing such as performing color space conversion on the sRGB signals and distributing the signals.

When the image data scanned by the scanner 400 is used for fax transmission or scanner transmission, the color calibration/UCR processing circuit 407 converts the image data into s-RGB signals or K (Gray) signals, and then the image data is distributed through the external interface I/F 421.

When printing the image data onto a transfer sheet, the color calibration/UCR processing circuit 407 converts the image data into CMYK data and the CMYK data is sent through the mutilayer bus 412. The feature amount extraction processing circuit 422 determines whether the image is an edge, non-edge, or weak edge which is the middle of an edge and non-edge. The printer γ conversion (2) circuit 423 performs a printer γ conversion process according to the determination result of edge, non-edge, or weak edge. The gradation processing circuit 424 performs a gradation process such as a binary or multivalue dither process, a binary or multivalue error diffusion process, or a binary or multivalue variation threshold error diffusion process.

As the dither process, it is possible to select a dither process of an arbitrary size, ranging from a non-dither process of 1×1, to a dither process of m×n pixels (m and n being a positive integer). In this example, it is possible to perform a dither process using up to 36 pixels. The size of the dither when using all 36 pixels is, for example, a total of 36 pixels including 6 pixels×main-scanning direction and 6 pixels×sub-scanning direction, or a total of 36 pixels including 18 pixels×main-scanning direction and 2 pixels×sub-scanning direction.

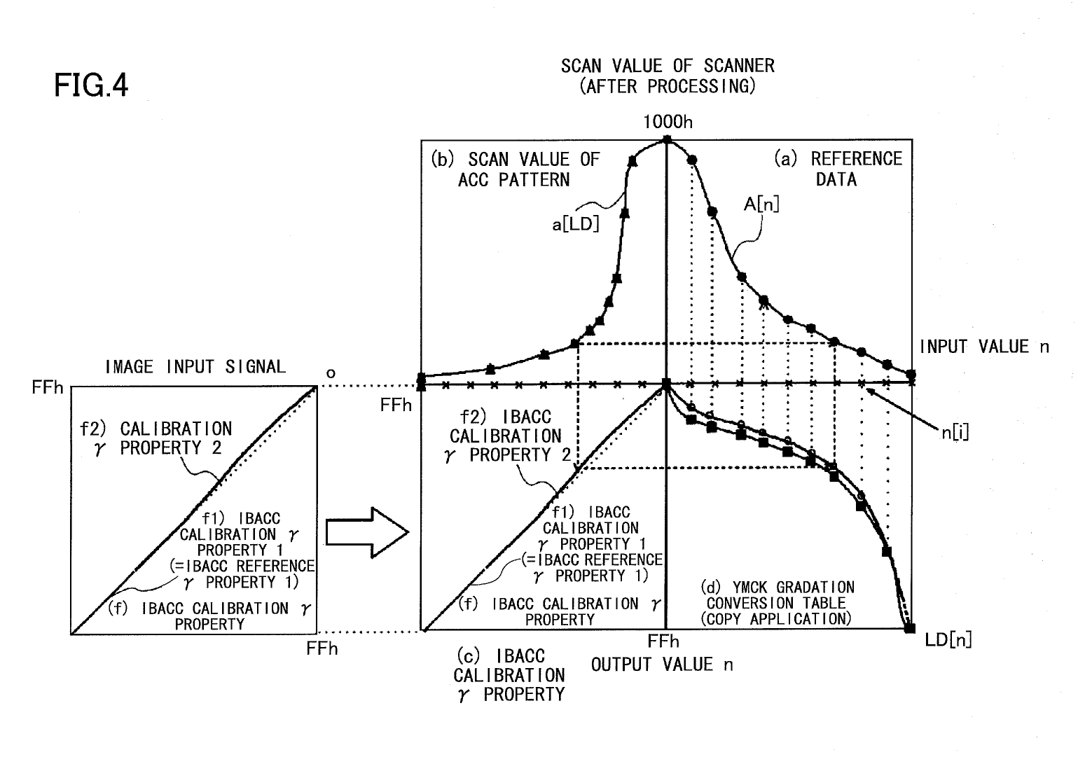

FIG. 4 is for describing a calibration process of the gradation conversion table according to an embodiment of the present invention. In the first quadrant (a) in FIG. 1, the horizontal axis indicates an input value n in the YMCK gradation conversion table, and the vertical axis indicates reference data A[i] which is a scan value of the scanner (after processing). The scan value of the scanner (after processing) is a value obtained by performing an averaging process and an addition process on the scanned data at several positions in the gradation pattern, with respect to the scan value obtained by scanning a gradation pattern with a scanner. For the purpose of increasing the calculation precision, the scan values are processed as 12 bit data signals.

In the second quadrant (b), the horizontal axis indicates a scan value of the scanner (after processing) similar to the vertical axis, and the horizontal axis expresses write values of a laser beam (LD), and the graph expresses scan values of an ACC pattern. The vertical axis expresses write values of a laser beam (LD). The data a [LD] expresses properties of the printer. Furthermore, as the write values of the LD of the gradation pattern to be actually formed, there are 16 points of 00h (background), 11h, 22h, . . . , EEh, FFh, which are skipped values; in this example, the values between the detection points are interpolated and handled as a continuous graph line.

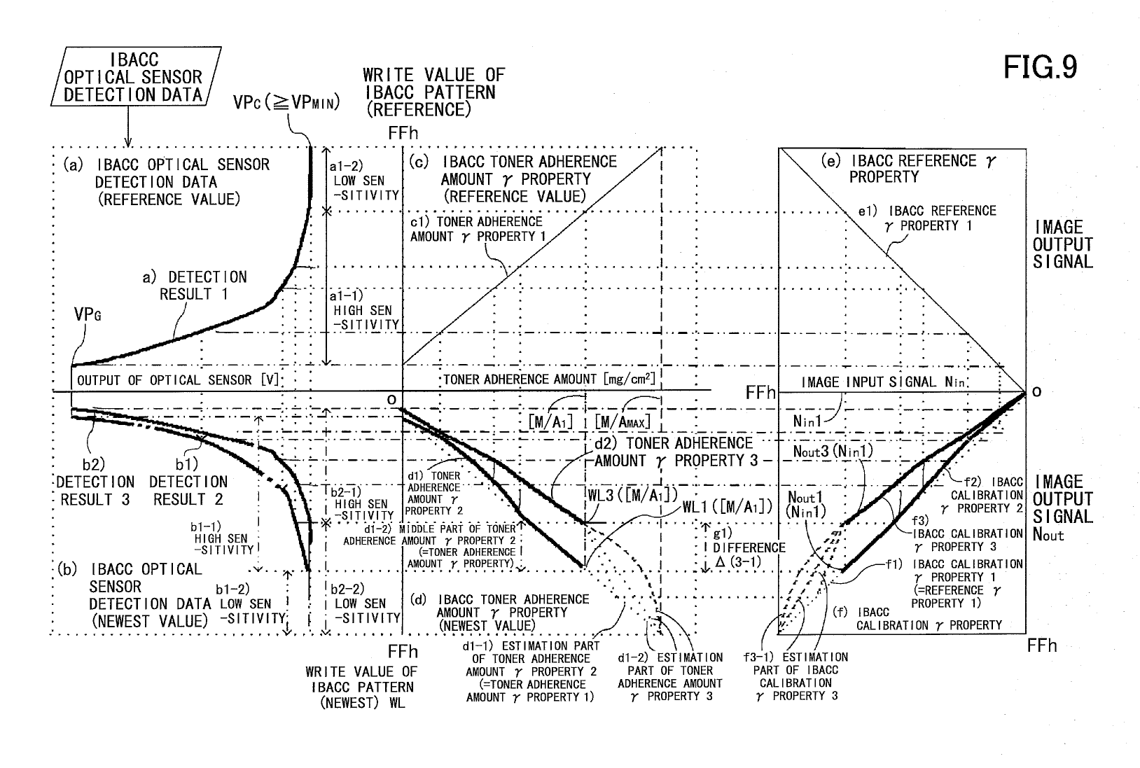

In the third quadrant, the vertical axis of the graph (f) expresses write values of the LD, and expresses IBACC calibration γ properties acquired by the operation illustrated in FIG. 9 described below. The (f1) IBACC calibration γ property 1 is an example of a linear table, and is also used as an IBACC reference γ property 1 used when executing ACC. The (f2) IBACC calibration γ property 2 is an example of an IBACC calibration γ property acquired by the operation illustrated in FIG. 9 described below.

In the fourth quadrant, the graph (d) is a YMCK gradation conversion table LD [i], and this table is obtained by a process according to an embodiment of the present invention.

The horizontal axis of the graph (d) is the same as that of the third quadrant (c), which expresses linear conversion as a matter of convenience, for expressing the relationship between the write value of the LD when creating a gradation pattern and a scan value of the scanner (after processing) of the gradation pattern. Reference data A [n] is obtained with respect to a certain input value n, and LD output LD [n] for obtaining A [n] is obtained along the arrow (1) in FIG. 4 with the use of a scan value a [LD] of the gradation pattern.

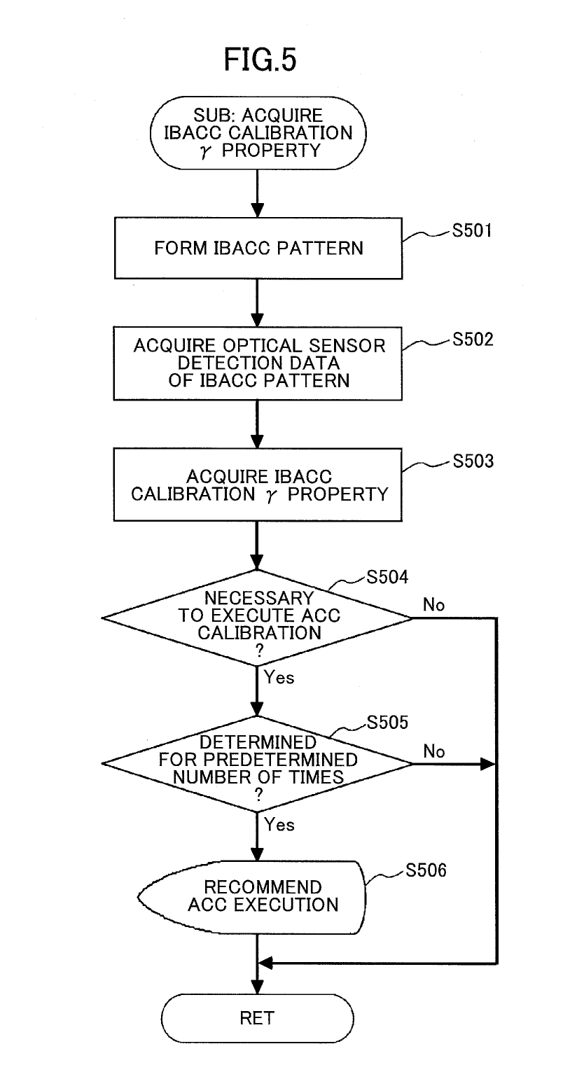

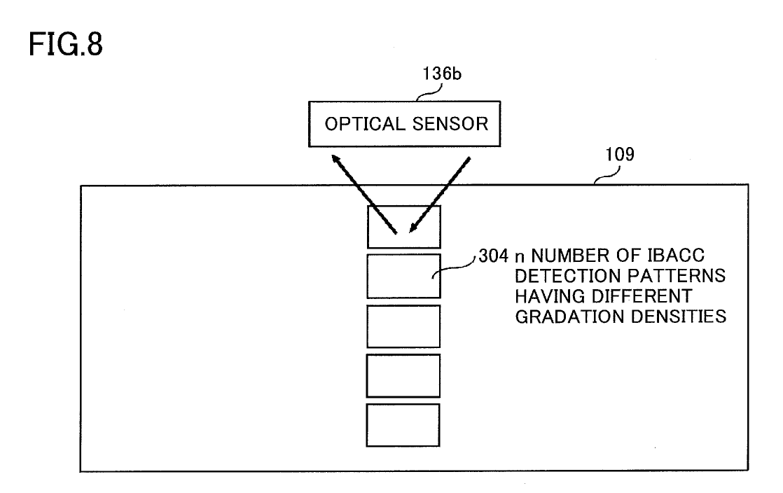

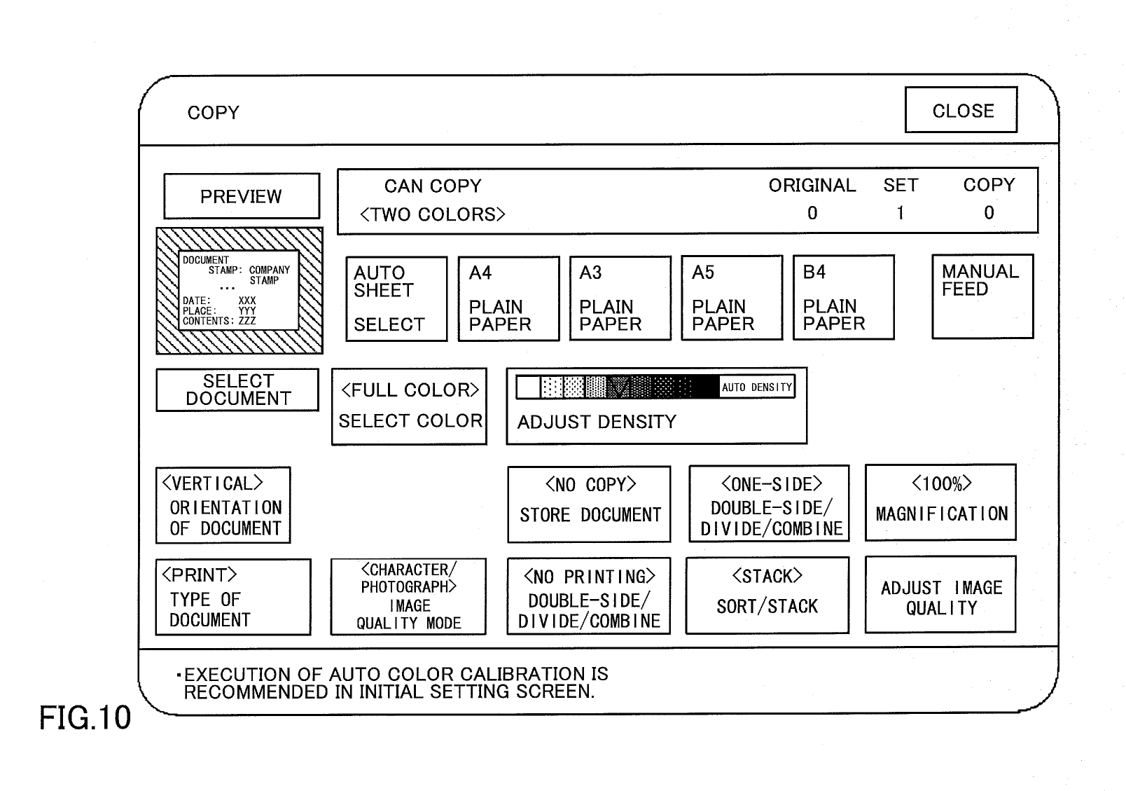

FIG. 5 is a flowchart of procedures for acquiring the IBACC calibration γ property of FIG. 4. This process is executed by the main control unit 130. In step S501, an IBACC pattern (reference pattern) is formed. In step S502, the IBACC pattern (reference pattern) is detected by an optical sensor, and the optical sensor detection data is acquired. In step S503, the IBACC calibration γ property is acquired from the optical sensor detection data of the IBACC pattern. In step S504, the main control unit 130 determines whether it is necessary to execute ACC calibration. In step S505, the main control unit 130 determines whether the number of times it has been determined that execution of ACC calibration is necessary has reached a predetermined number. In step S506, when the number of times has reached a predetermined number, this is displayed on an operation unit screen, and a report is given to the user to execute ACC calibration. Note that details of steps S501 and S502 are described with reference to FIG. 8, details of steps S503 and S504 are described with reference to FIG. 9, and details of step S506 are described with reference to FIG. 10.

The above process is performed every time images are formed on a predetermined number of transfer sheets (for example, 10 sheets through 100 sheets). Furthermore, in the case of an image processing device including a temperature and humidity sensor that can detect the temperature and humidity in the device, the above process is performed when the variation in the temperature and humidity exceeds a variation amount determined in advance.

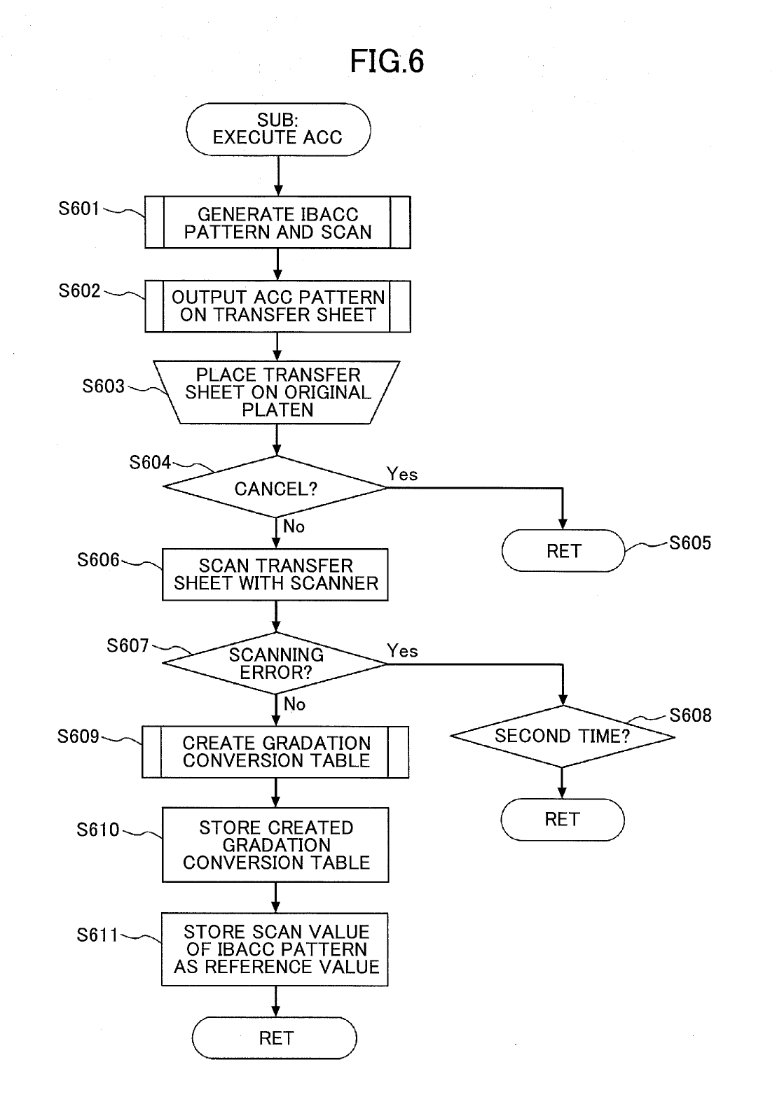

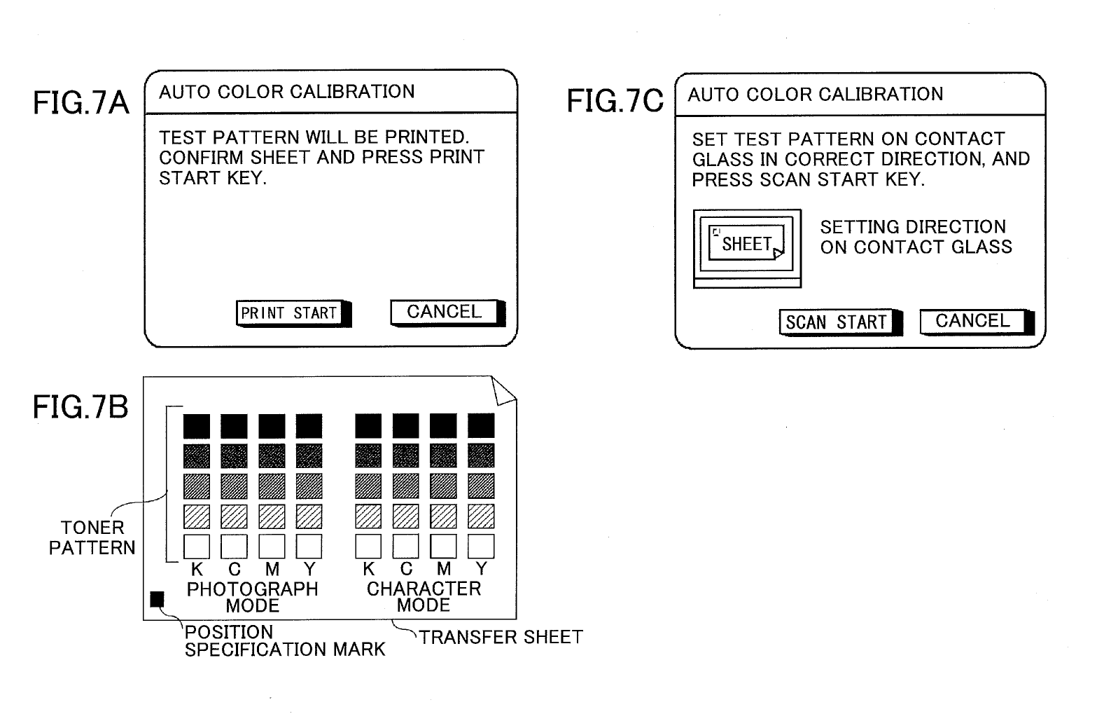

A description is given of an operation screen for selecting a function of ACC (Auto Color Calibration) of the image density (gradation properties). FIG. 6 is a process flowchart of ACC execution. This process is executed by the main control unit 130. When execution of automatic color calibration when using a printer is selected, the screen of FIG. 7A is displayed.

When a print start key in the screen of FIG. 7A is pressed, a plurality of density gradation patterns of the respective colors of YMCK are formed on a transfer material, as illustrated in FIG. 8 (step S601). A plurality of density gradation patterns corresponding to the respective colors of YMCK and the respective image quality modes of characters and photographs, as illustrated in FIG. 7B, are formed on the transfer material (step S602). These density gradation patterns are stored/set in the ROM of the CPU in advance. As the write values of the pattern, there are 16 patterns displayed as hexadecimal values of 00h, 11h, 22h, . . . , EEh, FFh. In FIG. 7B, patches of five gradations are displayed excluding the background part; however, it is possible to select an arbitrary value among the 8 bit signals of 00h-FFh. In the character mode, a dither process such as a pattern process is not performed, and a pattern is formed by 256 gradations per dot; and in the photograph mode, a dither process is performed.

The following are examples of gradation processes used in a copier, in the photograph mode pattern and the character mode pattern. Specifically, in the photograph mode pattern, for example, a line-by-line error diffusion process using a quantization threshold having a multivalue periodicity is used. In the character mode pattern, for example, a spatially constant, multivalue error diffusion process using a quantization threshold without a periodicity is used.

Meanwhile, in the photograph mode pattern and the character mode pattern used in a printer, different gradation processes are respectively used according to the type of image data to be printed, such as a picture object pattern or a figure object pattern. For a picture object pattern, a multivalue dither process by a Bayer pattern of a low number of lines is performed. For a figure object pattern, a multivalue or binary dither process of a high number of lines is performed. As described above, the gradation process performed in a copier and the gradation process performed in a printer are usually different.

After a pattern is output on a transfer material, a screen of FIG. 7C is displayed on the operation screen, indicating to place the transfer material on the original platen. In accordance with the instruction in the screen, the transfer material on which a pattern has been formed is placed on the original platen (step S603), and either “start scanning” or “cancel” is selected in the screen of FIG. 7C (step S604). When cancel is selected, the process ends (step S605). When start scanning is selected, the scanner moves and scans the RGB data of the YMCK density pattern (step S606). At this time, the data of the pattern part and the data of the background part of the transfer material are scanned.

The main control unit 130 determines whether the data of the pattern part has been properly scanned (step S607). When the data of the pattern art is not properly scanned, the screen of FIG. 7C is displayed again. When the data of the pattern part is not properly scanned twice, the process ends (step S608).

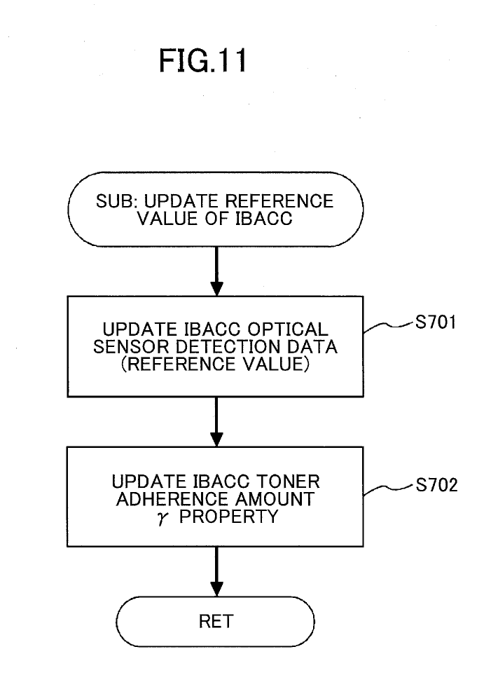

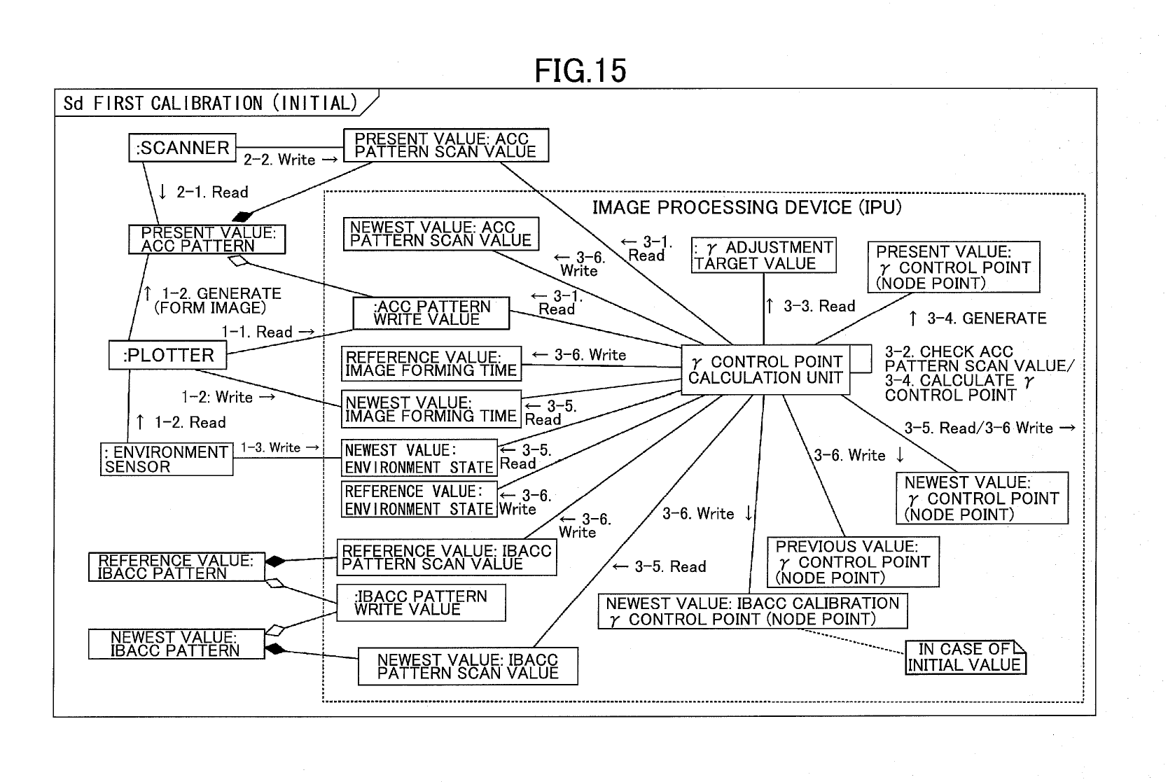

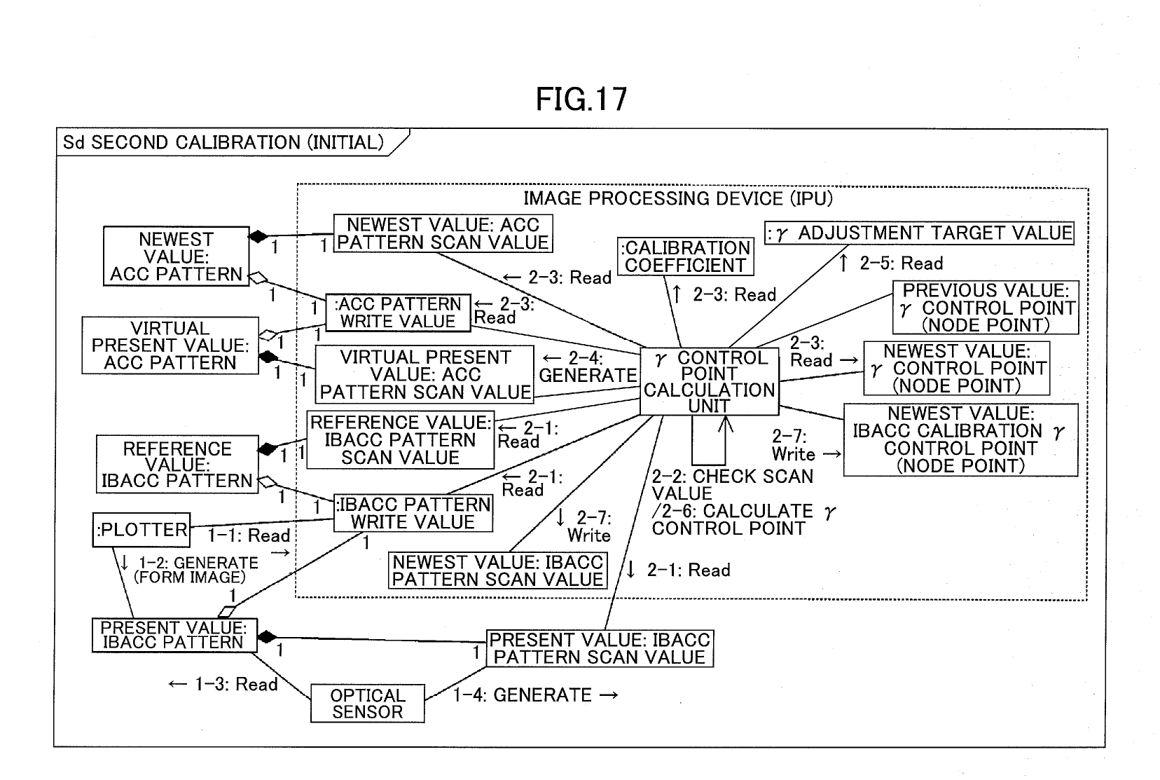

When the data of the pattern part is properly scanned, the main control unit 130 creates a gradation conversion table for the character area and for the photograph area, with respect to each of the YMCK color versions, based on the scan values of the ACC pattern (step S609), and stores the created gradation conversion table (step S610). At this time, the scan values of the ACC pattern acquired at step S606 may be stored. The scan values of the IBACC gradation pattern obtained in step S601, or the scan values of the IBACC gradation pattern formed on the image carrier most recently, are stored as new reference values (step S611). Details of step S611 are described with reference to FIG. 11. Furthermore, in step S505 of FIG. 5, the number of times the execution of ACC (Auto Color Calibration) has been determined is measured; however, by the process of step S611, the number is cleared to zero. An example of the data flow of step S601 is described with reference to FIG. 17, and an example of the specific data flow of steps S602 through S611 is described with reference to FIG. 15.

FIG. 8 illustrates an IBACC pattern formed on an image carrier (intermediate transfer belt). The optical sensor 136b detects the reflectance ratio of an n number of IBACC patterns having different gradations formed on the intermediate transfer belt 109 that is an image carrier, and the reflectance ratio is used as detection data (reference value) of the optical sensor.

With regard to this pattern, an image needs to be formed within a short period of time, and therefore the detection pattern to be used does not necessarily match the gradation pattern for the dither process and the error diffusion process described with reference to FIG. 7B; a binary zigzag pattern or a binary line pattern may be used as the detection pattern.

FIG. 9 is for describing a method of determining whether ACC execution is necessary of step S504 in FIG. 5, with the use of a quaternion chart including graphs (a) through (d).

The graph (a) in the second quadrant of FIG. 9 expresses IBACC optical sensor detection data (reference value), and the horizontal axis indicates the detection output [V] of the IBACC optical sensor, and the vertical axis indicates the write value of the IBACC pattern. The detection data obtained by the IBACC optical sensor of the IBACC pattern, which is formed at a predetermined timing when executing ACC, is indicated as a1 detection result 1.

The graph (c) in the first quadrant expresses the IBACC toner adherence amount γ property (reference value), and the horizontal axis expresses the toner adherence amount [mg/cm²] on the image carrier (transfer belt or photoreceptor). A c1 adherence amount γ property 1 is indicated as an example of data expressing the relationship with the toner adherence amount on the image carrier (intermediate transfer belt 109) corresponding to the a1 detection result 1. The relationship between the a1 detection result 1 and the graph (c) is obtained at the time of designing the device.

With respect to the graph a1 detection result 1, a1-1 expresses a range where the sensitivity with respect to the toner adherence amount is high, and a1-2 expresses a range where the sensitivity with respect to the toner adherence amount is low. In the range of the graph a1-2, the toner adherence amount varies, but the difference is small as detection data of the (a) optical sensor, and it is not possible to acquire the accurate toner adherence amount from the detection result of the optical sensor.

The graph (b) in the third quadrant expresses IBACC optical sensor detection data (newest value), and the vertical axis expresses the write value of the detection pattern (newest). As examples of detection results, b1 detection result 2 and b2 detection result 3 are indicated. The b1 detection result 2 and b2 detection result 3 are of different detection timings from that of the a1 detection result 1. As described above, the a1 detection result 1 is the result obtained by the detection at a predetermined timing when executing ACC, while the b1 detection result 2 and b2 detection result 3 indicate the result obtained by the detection after a predetermined time has passed from the ACC execution, or after developing a predetermined number of sheets after the ACC execution, or after the environment has changed in temperature/humidity, etc., after the ACC execution. With respect to the b1 detection result 2, b1-1 expresses a range where the sensitivity with respect to the toner adherence amount is high, and b1-2 expresses a range where the sensitivity with respect to the toner adherence amount is low. Furthermore, with respect to the b2 detection result 3, b2-1 expresses a range where the sensitivity with respect to the toner adherence amount is high, and b2-2 expresses a range where the sensitivity with respect to the toner adherence amount is low.

The graph (d) in the fourth quadrant expresses an IBACC toner adherence amount γ property (newest value). The toner adherence amounts obtained from the b1 detection result 2 and the b2 detection result 3 are indicated as d1 toner adherence amount γ property 2, and d2 toner adherence amount γ property 3, respectively. It is not possible to acquire the accurate toner adherence amount from the detection data of the optical sensor in the areas b1-2 and b2-2 where the sensitivity with respect to the toner adherence amount is small, and therefore, these are expressed as an estimation part of the d1-1 toner adherence amount γ property 2, and an estimation part of the d2-1 toner adherence amount γ property 3, which are indicated by dotted lines.

From the high sensitivity area b1-1 of the b1 detection result 2, it is possible to estimate that the estimation part of the d1-1 toner adherence amount γ property 1 matches the toner adherence amount of the c1 toner adherence amount γ property 1, when the middle part of the d1-2 toner adherence amount γ property 2 matches the c1 toner adherence amount γ property 1 within a predetermined error range in the d1 toner adherence amount γ property 2, which is obtained by using the c1 toner adherence amount γ property 1 and the a1 detection result 1.

Meanwhile, the d2 toner adherence amount γ property 2 corresponding to the low sensitivity area b2-2 of the b2 detection result 3 can be estimated as probably being a property as exemplified by the estimation part of the d2-1 toner adherence amount γ property 3, and this cannot be uniquely determined.

Next, a description is given of a method of determining whether it is necessary to execute ACC, by using the quaternion chart of FIG. 9 including graph (c) as the third quadrant, graph (d) as the fourth quadrant, graph (e) as the first quadrant, and graph (f) as the second quadrant.

Graph (e) indicates an IBACC reference γ property, in which the horizontal axis indicates image input signals, and exemplifies e1 IBACC reference γ property 1. Graph (f) indicates an IBACC calibration γ property, and f2 IBACC calibration γ property 2 and f3 IBACC calibration γ property 3 are obtained, in accordance with d1 toner adherence amount γ property 2 and d2 toner adherence amount γ property 3, respectively. With respect to the estimation part of the d1-1 toner adherence amount γ property 2, it is possible to use the f1 IBACC calibration γ property 1 matching the e1 IBACC reference γ property 1.

Meanwhile, with respect to the estimation part of the d2-1 toner adherence amount γ property 3, the estimation part of the f3-1 IBACC calibration γ property 3 is illustrated, which cannot be uniquely determined. When a calibration γ property as indicated by the f3 IBACC calibration γ property 3 is acquired, it is determined that ACC (Auto Color Calibration) needs to be executed, and a report is given to the user to execute ACC (Auto Color Calibration) by an operation screen as illustrated in FIG. 10, for example. As illustrated in FIG. 10, when the ACC execution is determined as necessary, a message such as “Execution of ACC (Auto Color Calibration) is recommended in the initial setting screen” is displayed at the bottom of the operation unit screen, for example.

In graph (d), the estimation part of the d1-1 toner adherence amount γ property 2 matches the c1 toner adherence amount γ property 1, and therefore the g1 difference Δ(3-1) expresses the difference between the c1 toner adherence amount γ property 1 and the d2 toner adherence amount γ property 3, in the write values of the IBACC pattern for obtaining a Predetermined toner adherence amount [M/A₁], or the difference in the image output signals with respect to the image input signals Nin1 in graph (f). That is to say, the following is obtained in graph (d): Δ(3-1)=(IBACC pattern write value in toner adherence amount γ property 1 for acquiring IBACC toner adherence amount [M/A₁])-(IBACC pattern write value in toner adherence amount γ property 3 for acquiring IBACC toner adherence amount [M/A₁])=WL3([M/A₁])−WL1([M/A₁]). When the obtained value exceeds a predetermined value ΔTh, i.e., when Δ(3-1)>ΔTh, it is determined that execution of ACC (Auto Color Calibration) is necessary.

The following is obtained: Δ(3-1)=(image output signal Nout in IBACC calibration γ property 3 for acquiring image input signal Nin1)−(image output signal Nout in IBACC calibration γ property 1 for acquiring image input signal Nin1)=Nout3(Nin1)−Nout1(Nin1). When the obtained value exceeds a predetermined value ΔTh, i.e., when Δ(3-1)>ΔTh, it is determined that execution of ACC (Auto Color Calibration) is necessary.

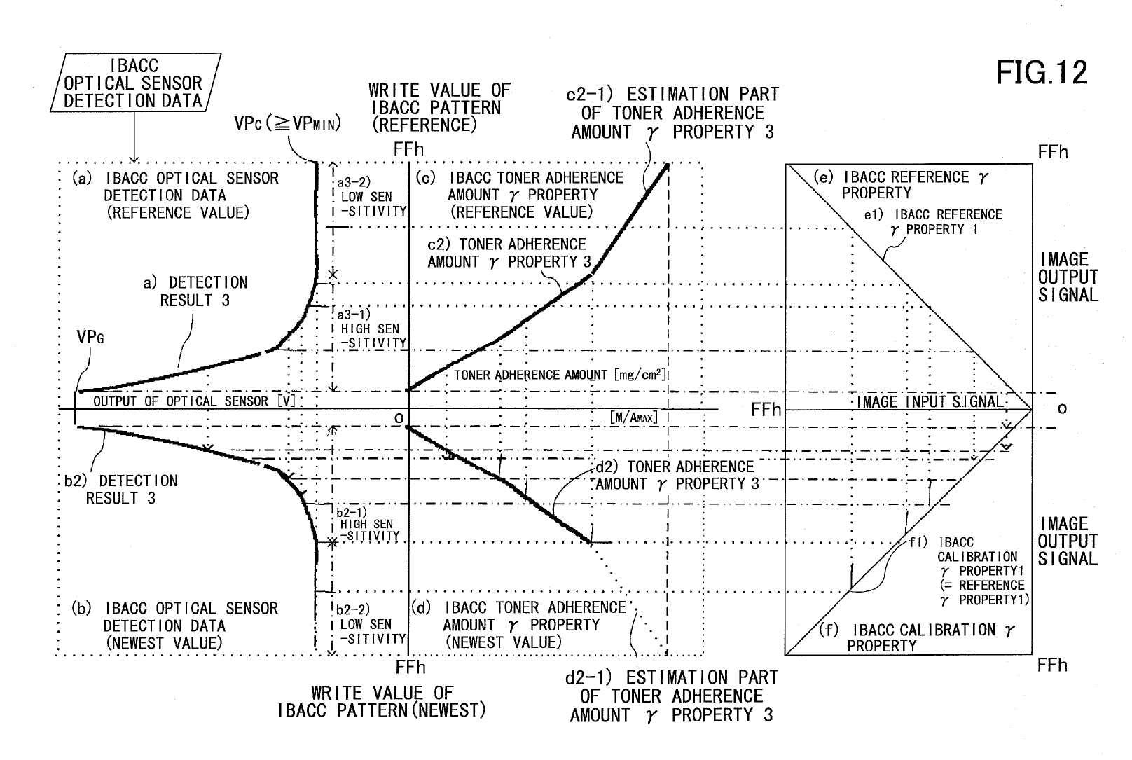

With reference to the flowchart of FIG. 11 and FIG. 12, a description is given of the process of updating the IBACC reference value when the b2 detection result 3 of graph (b) of FIG. 9 is obtained, and ACC (Auto Color Calibration) is executed. This process is executed by the main control unit 130.

In step S701 of FIG. 11, the b2 detection result 3 is used as a new reference value a2 detection result 3 of the graph (a) optical sensor detection data (reference value). In step S702, the d2 toner adherence amount γ property 3 is used as the new reference value c2 toner adherence amount γ property 3 of the (c) toner adherence amount γ property.

In FIG. 12, the contents of graphs (a) through (f) are the same as those of FIG. 9. In step S702 of FIG. 11, by executing ACC (Auto Color Calibration), the gradation corresponding to the IBACC pattern write value in the b2-2 low sensitivity area, is adjusted such that a predetermined gradation property is obtained. Therefore, the estimation part of the d2-1 toner adherence amount γ property 3 is arbitrarily determined by performing interpolation by a linear function or by spline interpolation, between the high sensitivity area b2-1 of the d2 toner adherence amount γ property 3 and the maximum adherence amount [M/A_{MAX}] of control in the image forming conditions.

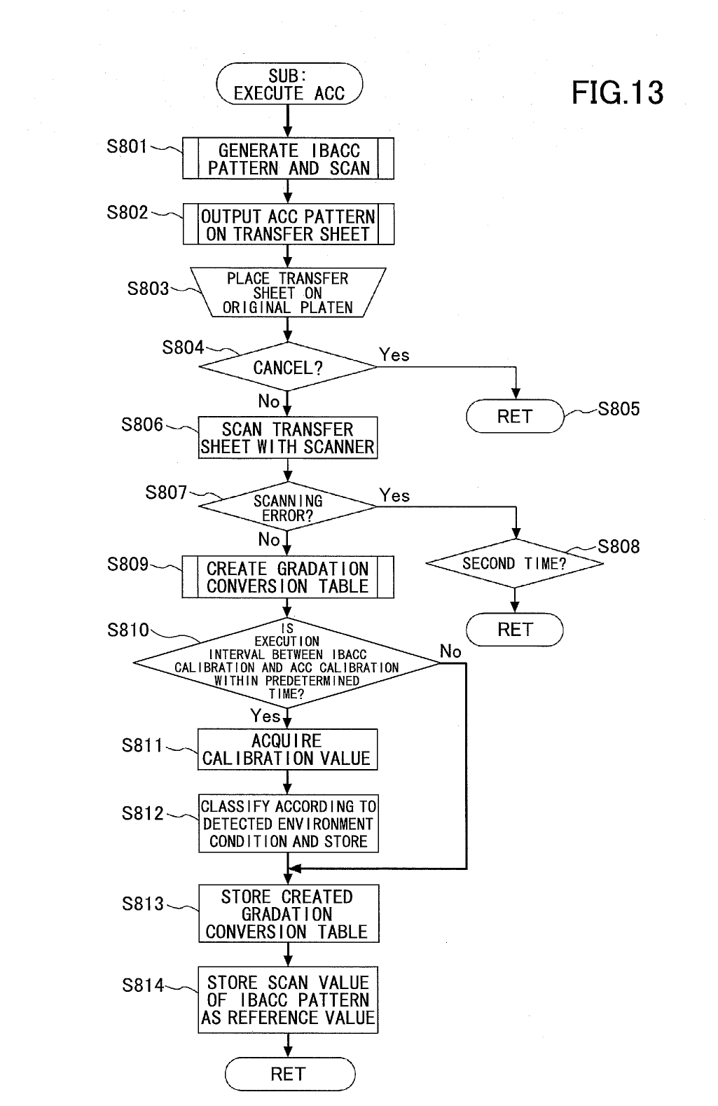

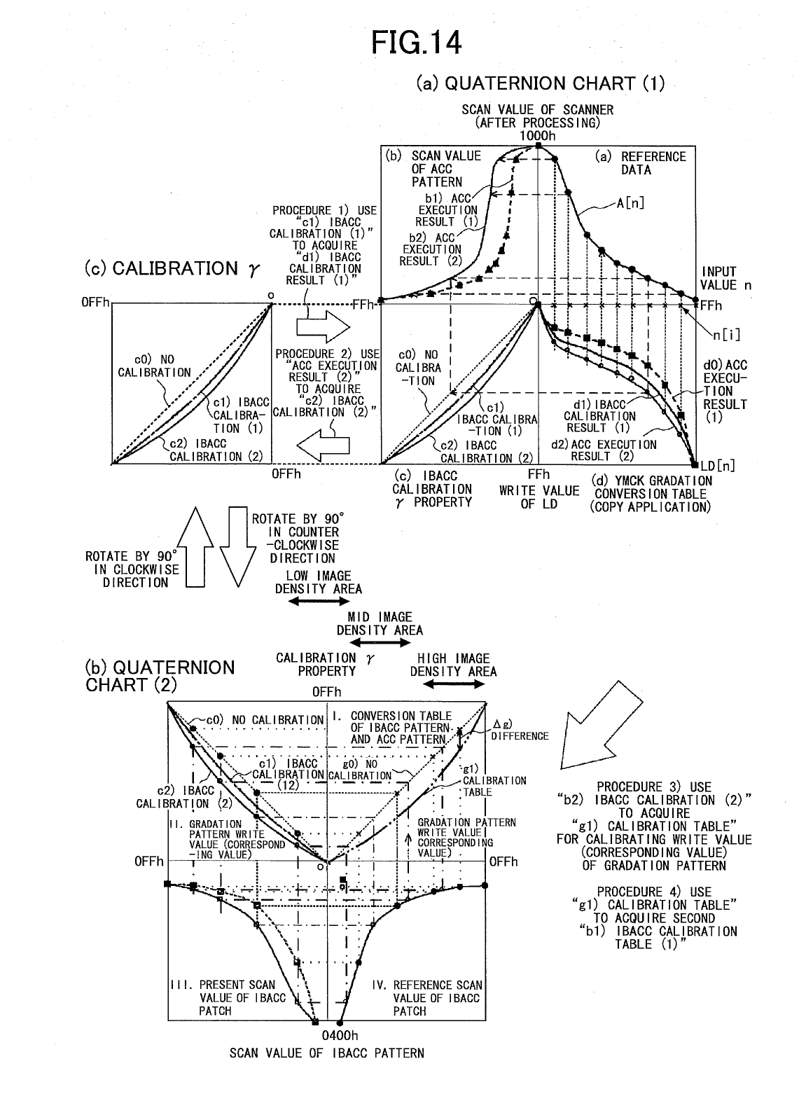

FIG. 13 is a flowchart of a process of acquiring a calibration value. Steps S801 through S808 of FIG. 13 are the same as steps S601 through S609 of FIG. 6. Furthermore, step S801 of FIG. 13 is an operation described by step S601 of FIG. 6, procedure 1 of FIG. 14, and FIG. 17.

In step S810, when the execution interval of step S801 and step S802 is greater than or equal to a predetermined time, steps S811 and S812 are not executed. Step S801 is usually automatically executed; however, step S802 and onward require an operation by the user or the service person such as placing a test print (test pattern) on the scanner, and therefore the execution interval may exceed the predetermined time.

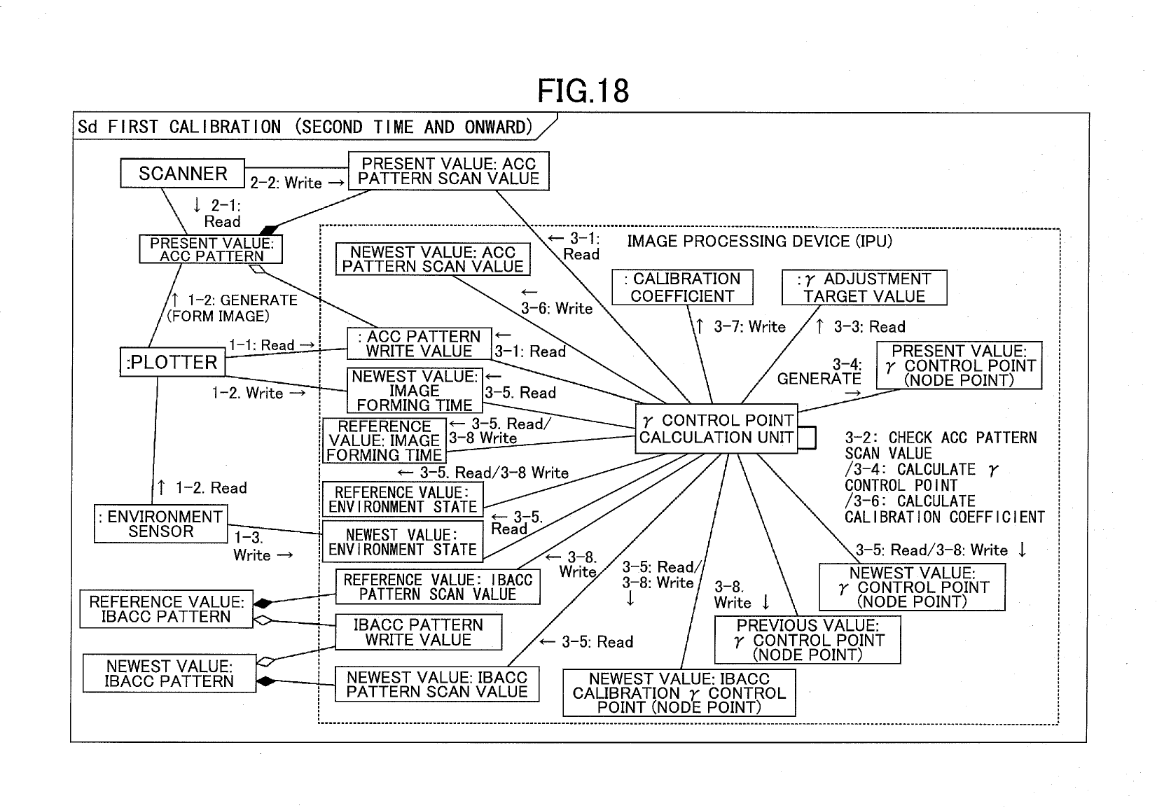

In step S811, a calibration value according to an embodiment of the present invention is acquired. Details of this operation are described by procedures 2 through 4 of FIG. 14. In step S812, the temperature and humidity inside the image forming apparatus is detected, classified according to detection conditions, and stored in a non-volatile RAM. Steps S811 and S812 are described by an embodiment of a specific dataflow with reference to FIG. 18. Steps S813 and S814 are the same as steps S610 and S611 of FIG. 6, respectively.

FIG. 14 is for describing the updating of a calibration value. The quaternion chart (1) of FIG. 14 (a) is described according to the flowchart of FIG. 6. The quaternion chart (2) of FIG. 14 (b) is described according to the flowchart of FIG. 5. The procedures 1), 2), and 3) are preferably performed continuously; however, image forming may be performed between the procedures or there may be a time interval, for example, procedure 3) may be performed on the next day of procedure 2). Furthermore, procedure 4) is not continuously performed after procedure 3); procedure 4) is a periodical operation that is performed when there is a time interval after forming images on 10 sheets or after forming images on 100 sheets.

In procedure 1), the property d1) the fourth quadrant is obtained, by setting the c1) calibration property (1) acquired by the process using the quaternion chart (2) of FIG. 14 (b), as (c1) of the third quadrant of the γ calibration (1) of FIG. 14 (a).

In procedure 2-1) of procedure 2), in the quaternion chart (1) of FIG. 14 (a), by performing steps S802 through S806 of the flowchart of FIG. 13, the graph b2) ACC execution result (2) of the second quadrant is acquired, and by performing step S809 of the flowchart of FIG. 13, the graph d2) ACC execution result of the fourth quadrant is obtained.

In procedure 2-2), in step S811 of FIG. 13, when the graph b1) ACC execution result (1) of the second quadrant and the graph d2) ACC execution result (2) of the fourth quadrant of the quaternion chart (1) of FIG. 14 (a) are selected, c2) IBACC calibration (2) is obtained as the graph of the third quadrant.

In procedure 3-1) of procedure 3), c2) IBACC calibration (2) obtained in procedure 2-2) is set as graph c2) IBACC calibration (2) of the second quadrant of the quaternion chart (1) of FIG. 14 (b), to obtain the calibration table of graph g1) of the first quadrant of the quaternion chart (2) of FIG. 14 (b). The graph g1) is the calibration property obtained by an embodiment of the present invention, and is stored in the non-volatile RAM in step S812 of the flowchart of FIG. 13. A plurality of types of the graph g1) according to the temperature/humidity in the image forming apparatus, are stored in the non-volatile RAM.

With respect to the difference between the graph g0) and the graph g1), the reliability of the value changes according to the execution interval between step S801 and step S802 of FIG. 13, or the execution interval between step S801 of FIG. 13 and step S802 of FIG. 13 performed several days ago. Therefore, the value may be multiplied by a coefficient (reflection rate) according to the reliability. For example, the reflection rate may be decreased in proportion to the execution interval and the image forming interval.

For example, the longer the interval between the execution interval between step S801 and step S802 of FIG. 13, or the execution interval between step S801 of FIG. 13 and step S802 of FIG. 13 performed several days ago, the coefficient (reflection rate) is decreased, and the difference Δg) between the graphs g0) and g1) is decreased. Furthermore, in the high image density area, the precision of the optical sensor is low with respect to the scanner, and therefore the coefficient is made lower than 100%.

In procedure 4), among the graphs g1) obtained in procedure 3-1), an appropriate graph g1) corresponding to the detected temperature/humidity in the device is used instead of graph g0), to perform the process described with reference to FIGS. 5 and 17. At this time, the difference g) between g0) and g1) may be calibrated (the coefficient may be decreased) according to the degree of deterioration of the developer.

FIG. 15 is for describing the first calibration (initial) operation. The data processing executed in the first calibration (initial) is described with reference to a collaboration diagram of UML (Unified Modeling Language) of FIG. 15.

In 1-1., ACC pattern write values are read from the memory.

In 1-2. and 1-3., the plotter forms an ACC pattern by the ACC pattern write values read in 1-1. At the same time, the image forming time is stored as a newest value in the non-volatile RAM. Furthermore, the measurement value of the environment sensor is stored as the newest value of the environment state in the in the non-volatile memory.

In 2-1., the ACC pattern formed in 1-2. is scanned with a scanner, and in 2-2., the present value of the ACC pattern scan value is generated.

In 3-1., the present value of the ACC pattern scan value, and the ACC pattern write value are loaded in a γ control point calculation unit realized by a CPU. In 3-2., it is checked whether there is abnormal scanning due to irregularities, in the present value of the ACC pattern scan value acquired in 3-1. When there are no abnormalities, the next step and onward are executed.

In 3-3., the γ gradation target value saved in the RAM or ROM is read.

In 3-4., the parameter acquired in 3-2. and 3-3. is used to calculate the present value of the γ control point (node point).

In 3-5. and 3-6., the newest value of the γ control point (node point) is stored as the previous value in the non-volatile RAM. The present value of the γ control point (node point) acquired in 3-4. is stored as the newest value of the γ control point (node point) in the non-volatile RAM. The newest value of the IBACC pattern scan value is stored as a reference value in the non-volatile RAM. The present value of the ACC pattern scan value is stored as the newest value in the non-volatile RAM. At the same time, the newest value of the image forming time is read, and stored as a reference value in the non-volatile memory. Furthermore, the newest value of the measurement value of the environment sensor is read, and stored as a reference value in the non-volatile RAM.

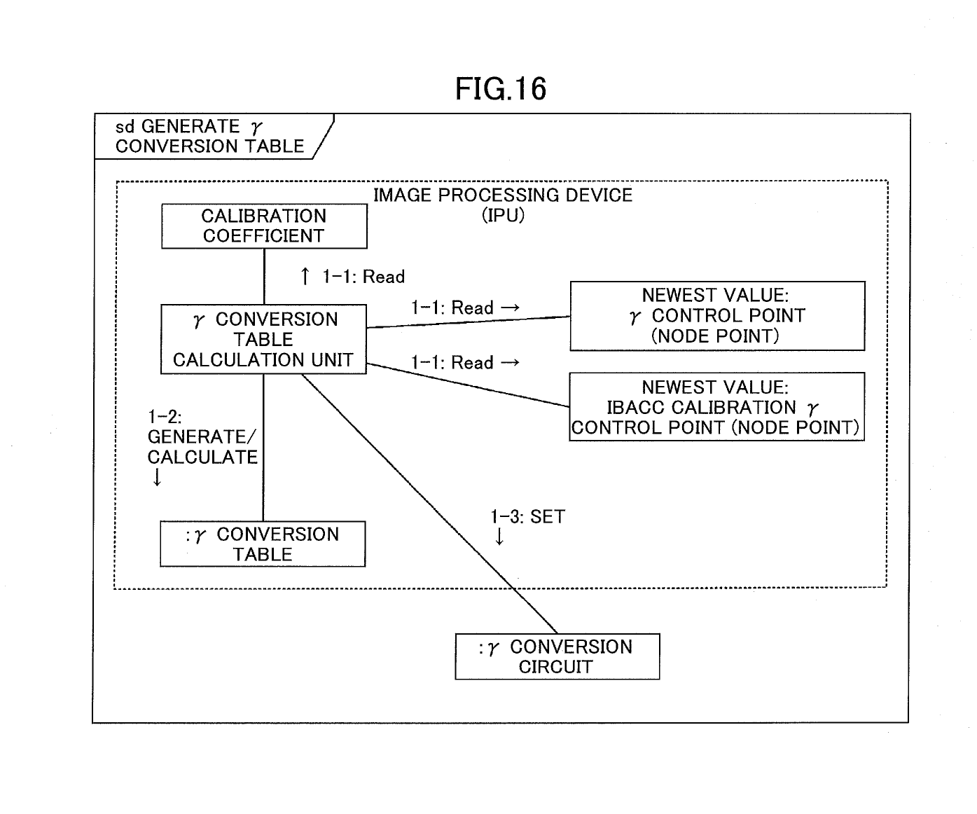

FIG. 16 is for describing the operation of generating a γ conversion table (LUT) for image processing. The flow of the data for creating a γ conversion table by spline interpolation by setting the γ control point (node point) stored in the non-volatile RAM as the node point, is described with reference to a collaboration diagram of UML of FIG. 16.

In 1-1., as parameters for creating the γ conversion table, the newest value of the γ control point (node point), the newest value of the IBACC calibration γ control point (node point), and the calibration coefficient, are acquired from the memory (non-volatile RAM) in which these parameters are saved.

In 1-2., with the use of the parameters acquired in 1-1., the γ conversion table is calculated by spline interpolation and is saved in the memory (non-volatile RAM).

In 1-3., the γ conversion table calculated in 1-2. is set in the γ conversion circuit.

FIG. 17 is for describing a second calibration operation.

In 2-1., IBACC pattern write values are read from the memory.

In 2-2., the plotter forms an IBACC pattern by the IBACC pattern write values read in 2-1.

In 2-3., the IBACC pattern formed in 2-2. is read by an optical scanner, and in 2-4., the present value of the IBACC pattern scan value is generated.

In 2-1., the present value of the IBACC pattern scan value, the reference value of the IBACC pattern scan value, and the IBACC pattern write value are loaded in a γ control point calculation unit realized by a CPU.

In 2-2., it is checked whether there is abnormal scanning in the present value of the IBACC pattern scan value acquired in 2-1. When there are no abnormalities, the next step and onward are executed.

In 2-3., the calibration coefficient, the newest value of the γ control point (node point), the write value of the ACC pattern, and the newest value of the ACC pattern scan value, which are saved in the RAM or ROM, are read.

In 2-4., a virtual present value of the ACC pattern scan value is calculated from the value acquired in 2-3., and temporarily saved in a storage memory.

In 2-5., a γ adjustment target value is acquired from the ROM or RAM.

In 2-6., the parameters acquired in 2-3. through 2-5. are used to calculate a γ control point (node point).

In 2-7., the γ control point (node point) acquired in 2-6. is saved as the newest value of the IBACC calibration γ control point (node point) in the non-volatile RAM.

FIG. 18 is for describing the first calibration (second time) operation. 1-1. through 3-4. are the same as FIG. 15.

In 3-5., the newest value and the reference value of the image forming time are read from the non-volatile RAM. The newest value and the reference value of the environment state are read from the non-volatile RAM. The newest value of the IBACC calibration γ control point (node point) is read from the non-volatile RAM. The newest value of the γ control point (node point) is read from the non-volatile RAM.

A description is given of the calculation of the calibration coefficient in 3-6. When the difference between the newest value and the reference value of the image forming time is higher than a predetermined value, the calibration value is not changed. The difference between the present value and the newest value of the γ control point (node point) is calculated, and compared with the difference with the newest value of the IBACC calibration γ control point (node point). When there is no difference between the two, the calibration coefficient becomes zero. When there is a difference between the two, the calibration coefficient is calculated based on the difference between the two.

In 3-7., the calibration coefficient obtained in 3-6. is stored in the non-volatile RAM. At this time, according to the newest value of the environment state, for example, the environment state is classified into the following environment conditions and stored. For example, the environment state is classified into 30° C. 100%, 25° C. 75%, 20° C. 50%, 15° C. 25%, and 10° C. 10%.

In 3-8., the newest value of the γ control point (node point) is stored as the previous value in the non-volatile RAM. The present value of the γ control point (node point) acquired in 3-4. is stored as the newest value of the γ control point (node point) in the non-volatile RAM. The newest value of the IBACC pattern scan value is stored as a reference value in the non-volatile RAM. The present value of the ACC pattern scan value is stored as the newest value in the non-volatile RAM. At the same time, the newest value of the image forming time is read, and stored as the reference value in the non-volatile RAM. Furthermore, the newest value of the measurement value of the environment sensor is read, and stored as the reference value in the non-volatile RAM.

As described above, in an embodiment of the present invention, the relationship between the gradation process pattern used in the second calibration and the gradation process pattern used in the first calibration is determined based on the comparison with the first calibration result at the time point when the difference of the calibration amount according to the second calibration has changed by a predetermined amount. Therefore, the calibration precision of the second calibration is improved. In an embodiment of the present invention, when performing a calibration process of the changes over time/environmental changes of the image carrier, with respect to the gradation conversion table used in the image processing, the timing of executing ACC (Auto Color Calibration) is determined in consideration of the gradation properties (slope of toner adherence amount γ) of the plotter (image carrier) and the change amount from the previous gradation property.

An embodiment of the present invention can be achieved by supplying, to a system or a device, a storage medium recording the program code of the software realizing functions of the above embodiments, and by reading and executing the program code stored in the storage medium by a computer (CPU or MPU) of the system or device. In this case, the program code itself read from the storage medium realizes the function of the above embodiments. As examples of the storage medium for supplying the program code, a hard disk, an optical disk, a magneto-optical disk, a non-volatile memory card, and a ROM may be used. Furthermore, by executing the program code read by the computer, not only are the functions of the above embodiments realized; based on the instruction of the program code, the OS (Operating System) operating on the computer may perform part of or all of the actual processes, and functions of the above embodiments may also be realized by these processes. Furthermore, after the program code read from the storage medium is loaded into a memory provided in a function extension board inserted in the computer or a function extension unit connected to the computer, based on the instruction of the program code, the CPU provided in the function extension board or the function extension unit may perform part of or all of the actual processes, and functions of the above embodiments may also be realized by these processes. Furthermore, the program for realizing the functions, etc., according to the embodiments of the present invention may be provided from a server by communication via a network.

According to one embodiment of the present invention, an image forming apparatus and an image forming method are provided, which are capable of improving the calibration precision of the second calibration.

The image forming apparatus and the image forming method are not limited to the specific embodiments described herein, and variations and modifications may be made without departing from the spirit and scope of the present invention.

The present application is based on and claims the benefit of priority of Japanese Priority Patent Application No. 2013-146487, filed on Jul. 12, 2013, the entire contents of which are hereby incorporated herein by reference.

What is claimed is:

1. An image forming apparatus comprising:
a scanning unit configured to scan an original image and acquire image data;
a γ conversion unit configured to perform γ conversion on the image data;
an image forming unit configured to form the image data on an image carrier and a transfer sheet;
a first calibration unit configured to perform first calibration of generating a calibration parameter to be set in the γ conversion unit, based on a scan value of a plurality of gradation patterns formed on the transfer sheet;
a second calibration unit configured to perform second calibration of generating a calibration parameter to be set in the γ conversion unit, based on a scan value of a plurality of gradation patterns formed on the image carrier; and
a changing unit configured to change the calibration parameter or a calibration amount with respect to the second calibration, based on a first calibration result of the first calibration, a second calibration result of the first calibration executed after a property of the image forming unit has changed, and a calibration result of the second calibration.

2. The image forming apparatus according to claim 1, further comprising:
a determination unit configured to determine a relationship between a gradation pattern to be used in the first calibration and a gradation pattern to be used in the second calibration, based on a first calibration amount according to the first calibration, a second calibration amount according to the first calibration executed after a property of the image forming unit has changed, and a calibration amount according to the second calibration.

3. The image forming apparatus according to claim 1, further comprising:
a first storage unit configured to store execution times of the first calibration and the second calibration;
an acquiring unit configured to acquire an environment condition including a temperature and a humidity; and
a second storage unit configured to store a number of times an image is formed between the first calibration and the second calibration, wherein
when an execution interval and an image forming interval between execution of the second calibration and execution of a second time of the first calibration are greater than or equal to a predetermined time and greater than or equal to a predetermined number of images, respectively, or when an environmental change is greater than or equal to a predetermined amount, a calibration is not executed with respect to the second calibration.

4. The image forming apparatus according to claim 1, further comprising:
a first storage unit configured to store execution times of the first calibration and the second calibration; and
a second storage unit configured to store a number of times an image is formed between the first calibration and the second calibration, wherein
when an execution interval and an image forming interval between execution of the second calibration and execution of a second time of the first calibration are less than a predetermined time and less than a predetermined number of images, respectively, a reflectance ratio is decreased in proportion to the execution interval and the image forming interval, the reflectance ratio being a ratio of reflecting the second calibration result of the first calibration to the calibration parameter or the calibration amount with respect to the second calibration.

5. The image forming apparatus according to claim 1, wherein
a reflectance ratio is obtained for each image density area including a low image density area, a mid image density area, and a high image density area, and
the reflectance ratio of the high image density area is set to be lower than those of the low image density area and the mid image density area.

6. The image forming apparatus according to claim 1, further comprising:
an environment condition detection unit configured to detect an environment condition including a temperature and a humidity, and
the calibration amount is stored according to the detected environment condition.

7. The image forming apparatus according to claim 5, further comprising:
an estimation unit configured to estimate a deterioration degree of a developer, based on a number of sheets on which images have been formed after replacing the developer, wherein
the reflectance ratio is decreased in accordance with the deterioration degree of the developer.

8. An image forming method comprising:
scanning an original image and acquiring image data;
performing γ conversion on the image data;
forming the image data on an image carrier and a transfer sheet;
performing first calibration of generating a calibration parameter to be set for the γ conversion, based on a scan value of a plurality of gradation patterns formed on the transfer sheet;
performing second calibration of generating a calibration parameter to be set for the γ conversion, based on a scan value of a plurality of gradation patterns formed on the image carrier; and
changing the calibration parameter or a calibration amount with respect to the second calibration, based on a first calibration result of the first calibration, a second calibration result of the first calibration executed after a property of the forming of the image data has changed, and a calibration result of the second calibration.

9. A non-transitory computer-readable recording medium storing a program that causes a computer to execute the image forming method according to claim 8.
